(19) United States
(12) Patent Application Publication
(10) Pub. No.: US 2019/0107806 A1
(43) Pub. Date: Apr. 11, 2019

(54) FUSER SHUTTER MECHANISM FOR AN IMAGING DEVICE

(71) Applicant: LEXMARK INTERNATIONAL, INC., LEXINGTON, KY (US)

(72) Inventors: VIRGIL JOHNSON, JR., VERSAILLES, KY (US); ABRAHAM ARGENIO MAGNAWA, CEBU CITY (PH); SETH EPHRAIM AMORA MIANO, CEBU CITY (PH); GLENNA DONATO SISANTE, PASAY CITY (PH); BYRONE AGUILAR VICTOR, LAPU-LAPU CITY (PH)

(21) Appl. No.: 15/728,602

(22) Filed: Oct. 10, 2017

(51) Int. Cl. G03G 15/20

(52) U.S. Cl. CPC G03G 21/1842; G03G 21/1685

(57) ABSTRACT

A fuser assembly includes a housing having a front defining an entrance through which a media sheet with a toner image enters the fuser assembly to fuse the toner image onto the media sheet, and a rear defining an exit through which the media sheet with fused toner image exits the fuser assembly. A safety shutter is mounted on the front of the housing and is movable between an unblocking position and a blocking position relative to the entrance. In the unblocking position, the shutter uncovers the entrance. In the blocking position, the shutter covers at least a portion of the entrance. The shutter moves from the unblocking position to the blocking position when the fuser assembly is exposed to access by a user. The shutter physically blocks off the entrance of the fuser assembly to prevent possible user contact with interior components of the fuser assembly.

### FIELD OF THE INVENTION

The present disclosure relates to a fuser assembly in an electrophotographic imaging device. It relates further to a door-actuated safety shutter mechanism for the fuser assembly.

### BACKGROUND

In an electrophotographic (EP) imaging process used in printers, copiers and the like, a photosensitive member, such as a photoconductive drum or belt, is uniformly charged over an outer surface. An electrostatic latent image is formed by selectively exposing the uniformly charged surface of the photosensitive member. Toner particles are applied to the electrostatic latent image, and thereafter the toner image is transferred to a media sheet. The toner image is fixed to the media sheet by the application of heat and pressure in a fuser. In a fuser having a belt fusing system, an endless belt surrounds a ceramic heater element. The belt is pushed against the heater element by a pressure roller to create a fusing nip through which media sheets pass during a fusing operation.

It is dangerous to touch the hot surfaces of the fuser assembly when heated to high temperature. In some belt fusing systems, highly thermally conductive (HTC) fuser belts are utilized to allow lower fusing temperatures while still achieving relatively high fuser grade. An HTC fuser belt is a polyamide plastic type of belt with fillers or thermally conductive additives which enhances the thermal conductivity of the belt resulting in a drop in the amount of temperature needed to fuse toner images to a media sheet. However, the HTC belt is also electrically conductive which changes its electrical safety classification from a plastic component to one that is similar to a steel component. As a result, the use of HTC belts introduces potential electrical safety hazards such as user electrocution if contact is made with it. To remove or reduce this safety hazard, some printers use an electrical relay to de-energize the fuser when the fuser is exposed for user access. While this approach has been met with success in terms of reducing risks of electrical shock, there always exists a need to minimize or eliminate risks of injury when handling fusers.

### SUMMARY

The foregoing and other are solved by a safety shutter mechanism for a fuser assembly that provides the ability to physically block off an entrance of the fuser assembly when exposed to access by a user in order to prevent possible user contact with interior components of the fuser assembly. In one embodiment, the fuser assembly includes a housing having a front and a rear. The front has a first opening through which a media sheet with a toner image enters the fuser assembly to fuse the toner image onto the media sheet. The rear has a second opening through which the media sheet with fused toner image exits the fuser assembly. A shutter is mounted on the front of the housing and is movable between an unblocking position and a blocking position relative to the first opening. In the unblocking position, the shutter uncovers the first opening. In the blocking position the shutter covers at least a portion of the first opening. An engagement member is movably mounted and exposed on a side of the fuser housing for receiving an actuation force from the imaging device. The engagement member operatively connects to the shutter such that the engagement member moves the shutter from the blocking position to the unblocking position upon receiving the actuation force.

In other embodiments, the engagement member receives the actuation force in response to an access door of the imaging device being closed. A linkage extends between the fuser assembly and the access door. The linkage is operatively connected to the shutter such that the shutter moves from the blocking position to the unblocking position when the linkage receives a forward force from the access door that is toward the front of the fuser assembly as the access door is closed. When the access door is opened, the forward force on the linkage is removed causing the shutter to move from the unblocking position to the blocking position. A stop feature is provided on the engagement member to block the shutter from moving towards the unblocking position while the access door is open and no actuation force is imparted to the engagement member. These and other embodiments are described below.

### BRIEF DESCRIPTION OF THE DRAWINGS:

FIG. 1 is a diagrammatic view of an imaging device, including cutaway with a diagrammatic view of a fuser assembly;

FIGS. 2A and 2B are diagrammatic views of the imaging device with a door-actuated safety shutter at an entrance of the fuser assembly;

FIG. 3 is a front perspective view of the fuser assembly and an actuation mechanism for the safety shutter according to an example embodiment;

FIG. 4 is a rear perspective view of the fuser assembly shown in FIG. 3;

FIG. 5 is an exploded view of an upper portion of the fuser assembly shown in FIG. 3;

FIG. 6 is a perspective view of the actuation mechanism in FIG. 3;

FIGS. 7A and 7B are top and front views, respectively, of the fuser assembly with the safety shutter in an unblocking position relative to the entrance of the fuser assembly;

FIGS. 8A and 8B are top and front views, respectively, of the fuser assembly with the safety shutter in a blocking position relative to the entrance of the fuser assembly;

FIG. 9 is a perspective view illustrating a locking mechanism for the safety shutter according to an example embodiment; and

FIGS. 10A-10C are sequential views illustrating operation of the locking mechanism shown in FIG. 9.

### DETAILED DESCRIPTION OF THE ILLUSTRATED EMBODIMENTS

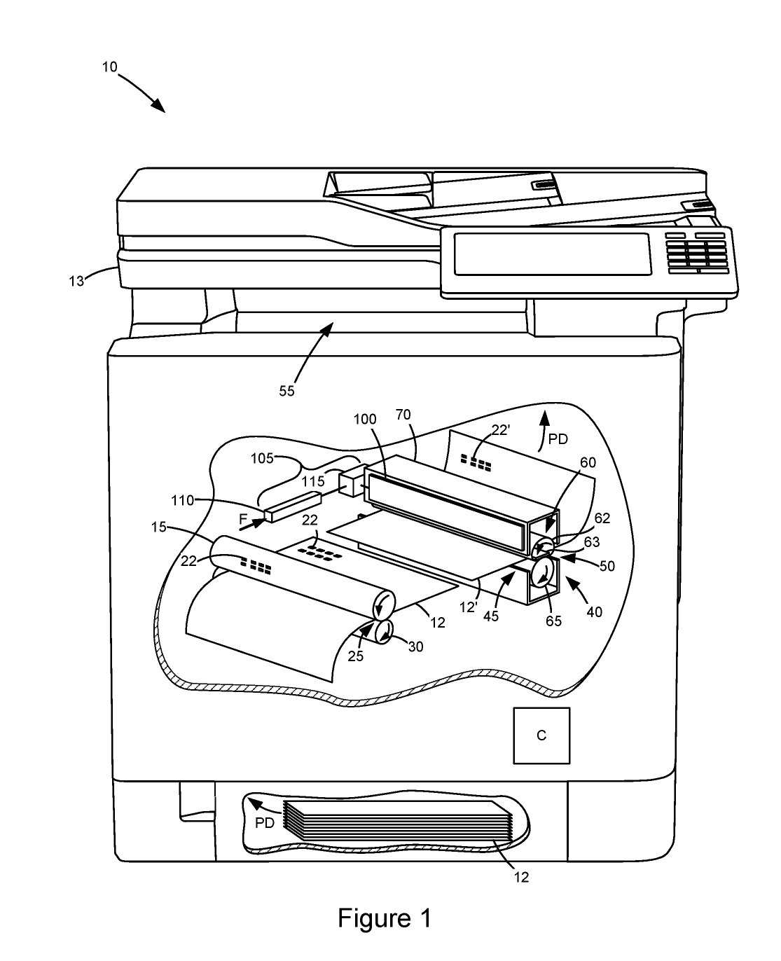

With reference to FIG. 1, a color electrophotographic imaging device 10 is shown according to an example embodiment. Imaging device 10 is used for printing images on media 12. Image data of the image to be printed on the media is supplied to imaging device 10 from a variety of sources such as a scanner 13, computer, laptop, mobile device, or like computing device. The sources directly or indirectly communicate with imaging device 10 via wired and/or wireless connection. A controller (C), such as an ASIC(s), circuit(s), microprocessor(s), etc., receives the image data and controls hardware of imaging device 10 to convert the image data to printed data on the sheets of media 12.

During use, controller (C) controls one or more laser or light sources (not shown) to selectively discharge areas of a photoconductive (PC) drum 15 to create a latent image of the image data thereon. Toner particles are applied to the latent image to create a toned image 22 on PC drum 15. At a transfer nip 25 formed between PC drum 15 and a transfer roll 30, the toned image 22 from PC drum 15 is transferred to a media sheet 12 travelling in a process direction PD. Media sheet 12′ with toned image 22 enters a fuser 40 through its entrance 45 to be applied with heat and pressure in order to fuse toned image 22 to media sheet 12′. Media sheet 12′ with fused toner image 22′ exits fuser 40 through its exit 50 and is either deposited into an output media area 55 or enters a duplex media path for transport to PC drum 15 for imaging on the other side of the media sheet 12.

In the example shown, fuser 40 has a heat transfer member 60 and a backup roll 65 disposed within a housing 70. Heat transfer member 60 and backup roll 65 forms a fusing nip therebetween. Heat transfer member 60 includes an endless fuser belt 62 and a heater 63 that contacts an inner surface of fuser belt 62 so that heat generated by heater 63 heats fuser belt 62 to a temperature sufficient to perform a fusing operation on sheets of media at the fusing nip. Heater 63 may be formed from a substrate of ceramic or like material to which at least one resistive trace is secured which generates heat when a current is passed through it. In one example, fuser belt 62 includes a highly thermally conductive (HTC) belt which is a polyamide plastic type of belt with thermally conductive additives to increase the thermal conductivity of fuser belt 62 and reduce the amount of temperature needed to sufficiently fuse toner images to sheets of media. The use of HTC belt allows fusing at lower temperatures which leads to lower energy consumption, less media curl, longer wear and fuser life, and reduced power requirements for fuser start up. Backup roll 65 contacts fuser belt 62 such that fuser belt 62 rotates in response to backup roll 65 rotating, as indicated by their direction arrows, to convey media through the fusing nip in process direction PD.

In a further embodiment, fuser 40 includes a safety shutter 100 positioned about its entrance 45 to provide the ability to block off possible user contact with interior components of fuser 40, including fuser belt 62, when entrance 45 is exposed to access by a user, such as when an access door of imaging device 10 is opened and fuser 40 is unobstructed. Blocking entrance 45 using shutter 100 may prevent electrocution, burns, and/or other possible injuries that may result from insertion of a user's finger into fuser 40 or the user otherwise reaching into and touching fuser belt 62 while fuser 40 is in its operational position within imaging device 10 ready to perform a fusing operation. When entrance 45 of fuser 40 is concealed from view of the user or otherwise not visually exposed for the user to access, such as when the access door of the imaging device is closed, shutter 100 is configured to unblock entrance 45 to allow feeding of media sheets through fuser 40.

The position of shutter 100 relative to entrance 45 is generally influenced by an actuation mechanism 105 including a linkage 110 and a force conversion mechanism 115 operably connected between shutter 100 and linkage 110. Linkage 110 is positioned to receive a forward force F that is in a direction towards entrance 45 of fuser 40 and force conversion mechanism 115 converts the forward force F imparted to linkage 110 into an opening motion of shutter 100 relative to entrance 45. In FIG. 1, forward force F applied to linkage 110 moves and holds shutter 100 in an unblocking position relative to entrance 45 to allow media sheet 12 to enter entrance 45 and pass through fuser 40. Removal of forward force F causes shutter 100 to move from the unblocking position to a blocking position relative to entrance 45 in order obstruct entrance 45 and block off access to interior components of fuser 40 including fuser belt 62.

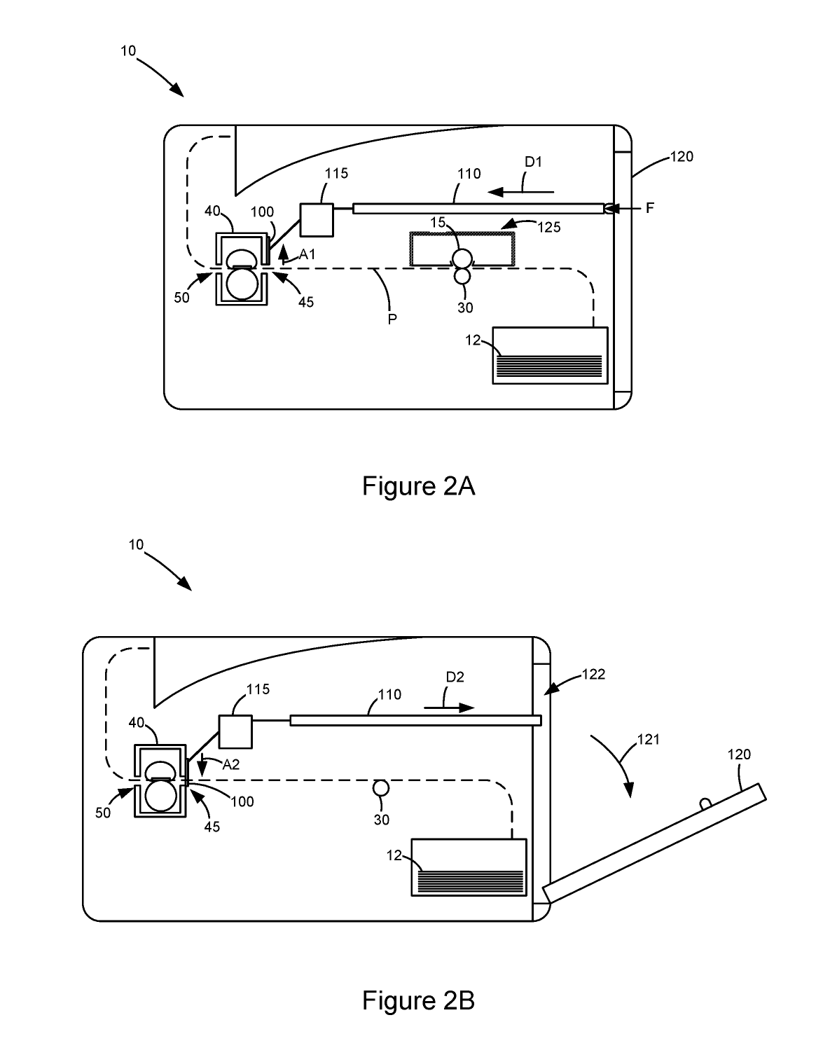

With reference to FIGS. 2A and 2B, the operation of safety shutter 100 will be described by way of example. As shown, imaging device 10 includes an access door 120 movable between a closed position (FIG. 2A) and an open position (FIG. 2B) relative to an opening 122 through which a user may access interior components of imaging device 10.

In FIG. 2A, imaging device 10 is shown having fuser 40 in its operational position with access door 120 in the closed position. One or more upstream sub-assemblies, generally designated with reference numeral 125 and including PC drum 15 and/or other customer replaceable units, are installed within imaging device 10 between access door 120 and fuser 40. Linkage 110 extends between fuser 40 and access door 120 and is generally actuated by the motion of access door 120. In the closed position (FIG. 2A), access door 120 engages and applies forward force F to linkage 110 moving linkage 110 in direction D1 towards fuser 40. In turn, force conversion mechanism 115 connected between linkage 110 and shutter 100 converts the motion of linkage 110 in direction D1 into an opening motion of shutter 100 in direction A1 unblocking entrance 45 of fuser 40 and allowing passage of sheets of media 12 through fuser 40 along a media path P. Although the example illustration shows access door 120 directly engaging linkage 110 to apply forward force F, other examples may include indirect engagement between access door 120 and linkage 110, such as by the use of one or more linkage or coupling mechanisms to transmit and convert a closing force of access door 120 to forward force F imparted to linkage 110.

In FIG. 2B, access door 120 has been opened as indicated by arrow 121 with the one or more upstream sub-assemblies removed from imaging device 10 while fuser 40 is still in its operational position. Removal of the upstream sub-assemblies may be necessary for various reasons, including replacement of print engine components such as a toner cartridge, a developer unit, and the PC drum. In the example shown, access to fuser 40 from access door 120 is unobstructed due to the removal of the one or more upstream sub-assemblies and a user may be able to reach into fuser 40 via opening 122 uncovered by access door 120. In the open position (FIG. 2B), access door 120 is disengaged from contacting linkage 110 thereby removing forward force F acting on linkage 110. In one example, force conversion mechanism 115 is spring-biased such that the absence of forward force F acting on linkage 110 allows force conversion mechanism 115 to move shutter 100 in direction A2 to block entrance 45 of fuser 40. In addition, the spring bias on force conversion mechanism 115 aids in moving linkage 110 in direction D2 towards access door 120 away from fuser 40. In other examples, other biasing mechanisms separate from that of force conversion mechanism 115 may be employed to urge linkage 110 to move toward access door 120 when forward force F is removed as the access door 120 is opened.

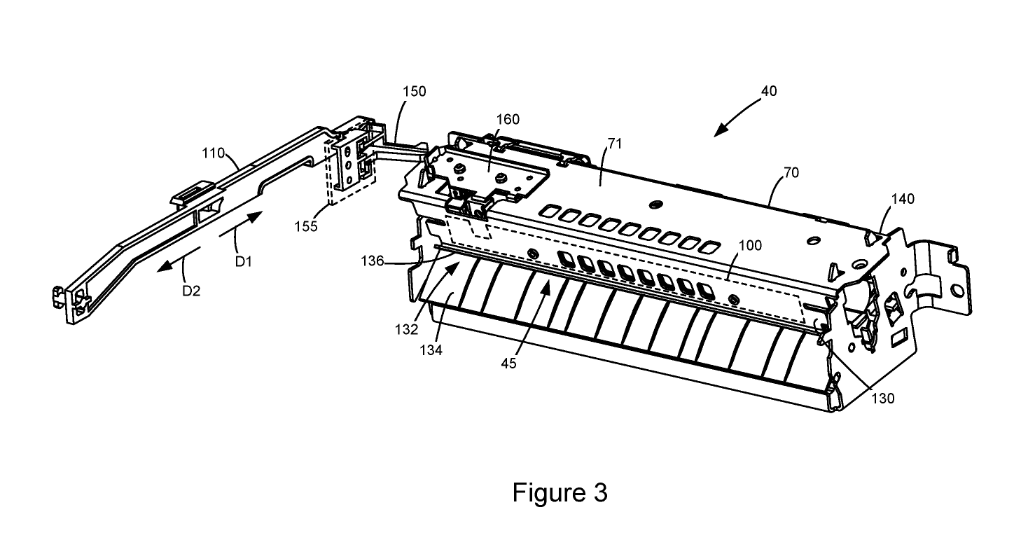

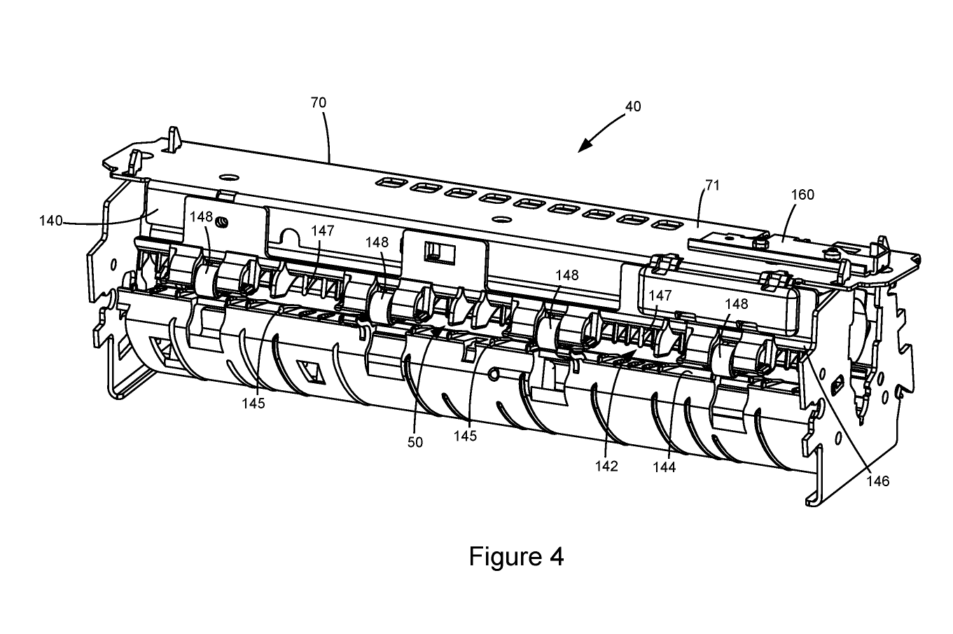

With reference to FIGS. 3-5, an example implementation of fuser 40 and the shutter mechanism therefor will be described. Fuser 40 includes housing 70 having a front 130 and a rear 140. In FIG. 3, front 130 includes a first opening 132 between a lower media guide 134 and an upper media guide 136 defining entrance 45 through which sheets of media enter fuser 40. In FIG. 4, rear 140 includes a second opening 142 between a lower guide member 144 and an upper guide member 146 defining exit 50 through which sheets of media with fused toner images exit fuser 40. Disposed along upper guide member 146 are a plurality of feed rolls 148 that are arranged to form feed nips with corresponding rolls in the imaging device when fuser 40 is installed therein.

Fuser 40 is shown in FIG. 3 with its front 130 having shutter 100 (shown in dashed lines) mounted within housing 70 and movable relative thereto between the unblocking position to uncover entrance 45 and the blocking position to cover at least a portion of entrance 45. Shutter 100 may be made of a thermally conductive material, such as sheet metal or any suitable material, which can withstand heat generated by fuser 40. Shutter 100 is actively actuated by linkage 110 via an actuator arm 150 pivotably mounted on a side frame 155 of the imaging device and a slider 160 slidably mounted on a top 71 of fuser housing 70. In this example, actuator arm 150 and slider 160 each forms part of the force conversion mechanism 115 illustrated in FIGS. 2A and 2B with actuator arm 150 disposed in the imaging device and slider 160 disposed in fuser housing 70. Actuator arm 150 and slider 160 are operatively coupled to each other and are used to transform the forward motion of linkage 110 in direction D1 towards fuser 40 into the opening motion of shutter 100. Conversely, the operative connection between actuator arm 150 and slider 160 causes the closing motion of shutter 100 when linkage 110 moves away from fuser 40 in direction D2. These will be discussed in further detail below.

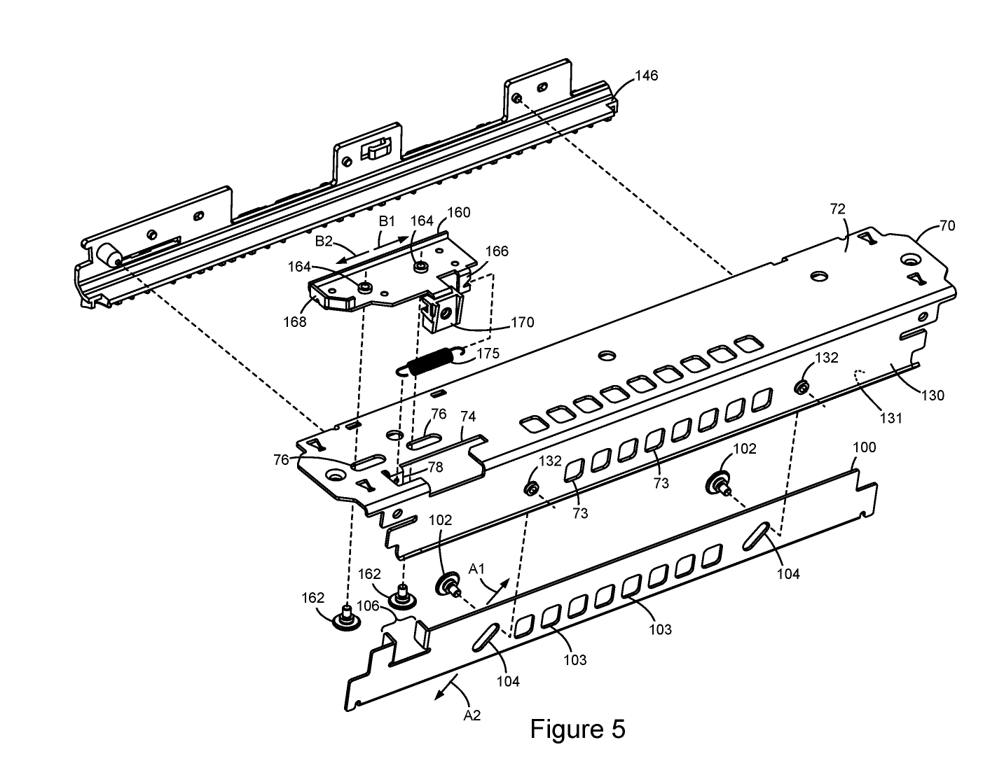

FIG. 5 illustrates an exploded view of an upper frame 72 of fuser housing 70. Shutter 100 is disposed on and coupled to front 130 of housing 70 and is slidingly attached thereto. In the example shown, shutter 100 is retained against an inner side 131 of front 130 by shoulder screws 102 each passing through a corresponding diagonal slot 104 on shutter 100 and fastened to front 130 via a corresponding screw hole 132 formed on upper frame 72. Diagonal slots 104 formed on shutter 100 extend parallel to each other with each diagonal slot 104 having a length that allows shutter 100 to translate up and down in diagonal directions A1, A2 while retained against front 130 of housing 70 by shoulder screws 104. (It is noted that direction arrows A1, A2 illustrated in FIGS. 2A and 2B are used to generally depict opening and closing motions of shutter 100, respectively. As such, although direction arrows A1, A2 illustrate vertical movement in FIGS. 2A and 2B, they are used to illustrate diagonal movement in FIG. 5 to still depict opening and closing motions of shutter 100). Other configurations with respect to movably mounting shutter 100 against front 130 of housing 70 are also possible. For example, the above configuration may be reversed such that shutter 100 includes screw holes and front 130 of housing 70 includes diagonal slots through which the shoulder screws may pass through to mate with corresponding screw holes on shutter 100. Shutter 100 further includes a retainer 106 positioned adjacent an opening 74 on upper frame 72 to interact with slider 160.

Slider 160 is generally an engagement member movably mounted on top 71 of upper frame 72 to receive an actuation force from the imaging device, such as from actuation arm 150 (FIG. 3). In the example shown, upper frame 72 includes elongated slots 76 for supporting the sliding motion of slider 160 in directions B1, B2 along the top 71 of housing 70. Shoulder screws 162 pass through corresponding elongated slots 76 and are fastened to slider 160 via corresponding screw holes 164 such that slider 160 is movable along directions B1, B2. An insert 170 extends downward from slider 160 through opening 74 and is received in retainer 106 of shutter 100 to operatively connect slider 160 to shutter 100. Insert 170 may be formed by the body of slider 160, or may be a separate element that is attached to the body of slider 160. Slider 160 is continuously biased to move in a direction away from a longitudinal central portion of housing 70 by a tension spring 175 connected between a hook arm 166 extending downward from slider 160 and a spring post 78 provided on top 71 of upper frame 72 within opening 74. With insert 170 of slider 160 inserted in retainer 106 of shutter 100, movement of slider 160 in directions B1, B2 moves shutter 100 in directions A1, A2, respectively. For example, as slider 160 moves away from the central portion of housing 70 in direction B2 due to the biasing force of tension spring 175, coupling between retainer 106 and insert 170 moves shutter 100 diagonally downward in direction A2 towards its blocking position. Conversely, as the biasing force of tension spring 175 is overcome and slider 160 moves toward the central portion of housing 70 in direction B1, shutter 100 moves diagonally upward in direction A1 towards its unblocking position. In the example shown, the biasing force of tension spring 175 is overcome when an engagement surface 168 of slider 160 is pushed, such as by actuator arm 150 (FIG. 3), to move slider 160 in direction B1 towards the central portion of housing 70.

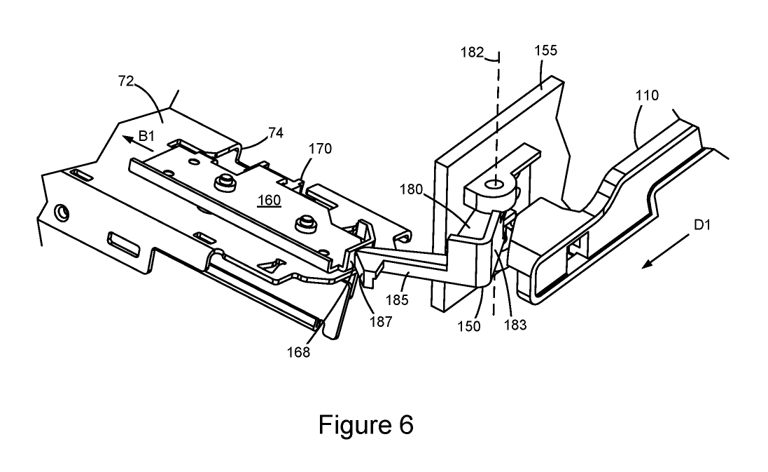

With reference to FIG. 6, actuator arm 150 includes a base 180 pivotably mounted about a pivot axis 182 on side frame 155 and an arm 185 depending at an angle from base 180. Base 180 includes a back surface 183 that is engagable by linkage 110 when linkage 110 is moved in forward direction D1 towards fuser 40 to rotate actuator arm 150 towards slider 160. A cam surface 187 is provided at the free end of arm 185 to contact against engagement surface 168 of slider 160 when actuator arm 150 is rotated by linkage 110 towards upper frame 72. Arm 185 extends at a length from base 180 such that cam surface 187 engages engagement surface 168 and moves slider 160 in direction B1 as actuator arm 150 rotates further towards slider 160. Cam surface 187 of arm 185 remains in contact with engagement surface 168 of slider 160 such as by using a torsion spring (not shown) continuously urging actuator arm 150 against slider 160. In one example, the biasing force on actuator arm 150 is selected to provide a minimum force required on actuator arm 150 that is sufficient to maintain contact between actuator arm 150 and slider 160. To reduce frictional resistance between contact points, cam surface 187 and engagement surface 168 are made from materials having relatively small coefficient of friction.

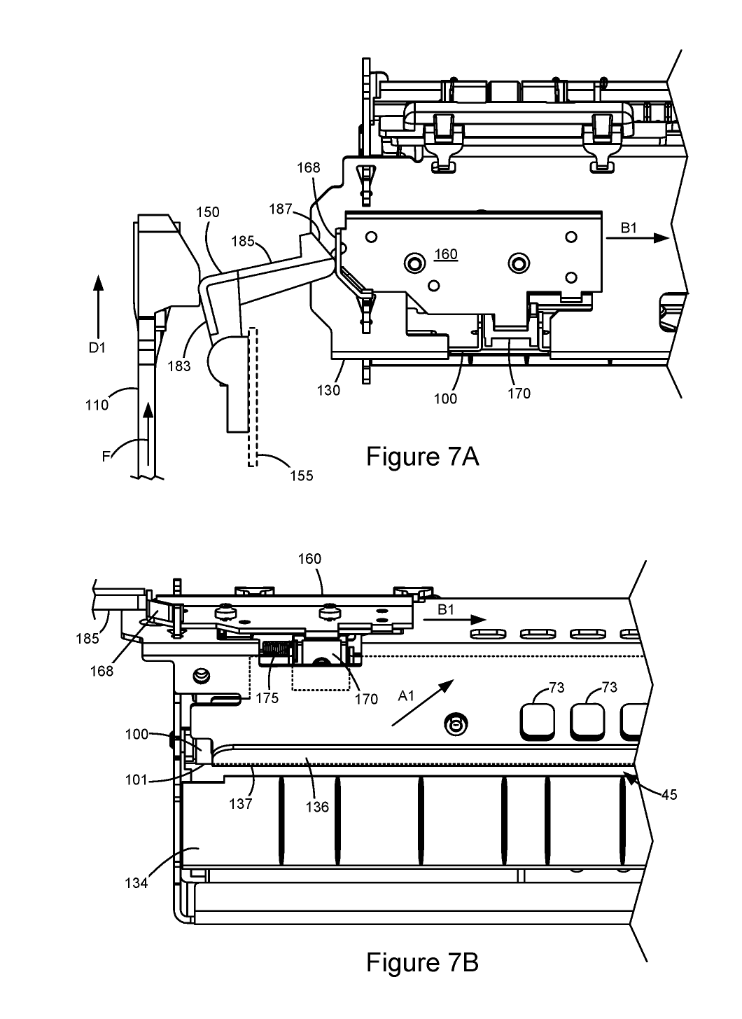

During use, a plunger or other projection extending from an inner side of the access door (or otherwise linked to the access door) applies forward force F on linkage 110. This causes linkage 110 to move forward towards fuser 40 and engage back surface 183 of actuator arm 150, as shown in FIGS. 7A and 7B, when the access door to the imaging device is closed. In turn, actuator arm 150 rotates in the clockwise direction, as viewed in FIG. 7A, toward slider 160 and cam surface 187 of arm 185 pushes engagement surface 168 of slider 160 overcoming the biasing force of tension spring 175 on slider 160 and causing slider 160 to translate in direction B1 and open shutter 100 in direction A1. In the example shown, slider 160 is in a fully-pushed position in which slider 160 has moved shutter 100 to the unblocking position with its bottom edge 101 substantially flush along or slightly above the bottom edge 137 of upper media guide 136 thereby uncovering entrance 45 and allowing media sheets to enter fuser 40. Perforations 103 on shutter 100 (FIG. 5) align with corresponding frame cutout geometries 73 on upper frame 72 to provide ventilation openings. Perforations 103 and cutout geometries 73 may have other shapes and may vary in size and position along a length of upper frame 72.

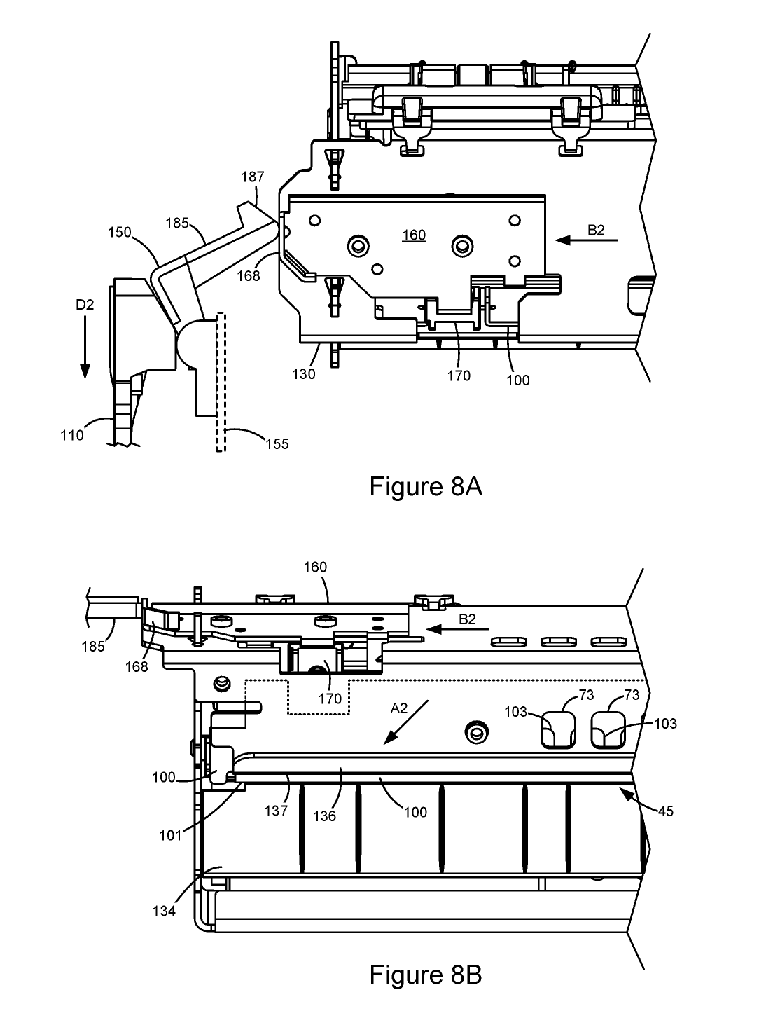

When the access door to the imaging device is opened, the forward force F acting on linkage 110 is eliminated and the sequence is reversed. That is, linkage 110 moves backward in direction D2 away from fuser 40 and the bias on slider 160 by tension spring 175 causes slider 160 to translate towards side frame 155 in direction B2 and close shutter 100 in direction A2, as shown in FIGS. 8A and 8B. In the example shown, slider 160 is in an unpushed position in which slider 160, although in contact with arm 185, has not been moved by actuator arm 150 in direction B2 and shutter 100 remains in the blocking position. Its bottom edge 101 resides below the bottom edge 137 of upper media guide 136 thereby covering entrance 45 and preventing access to interior components of fuser 40. In addition, perforations 103 on shutter 100 are misaligned relative to frame cutout geometries 73 on upper frame 72 covering at least portions of the ventilation openings and reduce the likelihood of access to interior components of fuser 40 via the ventilation openings.

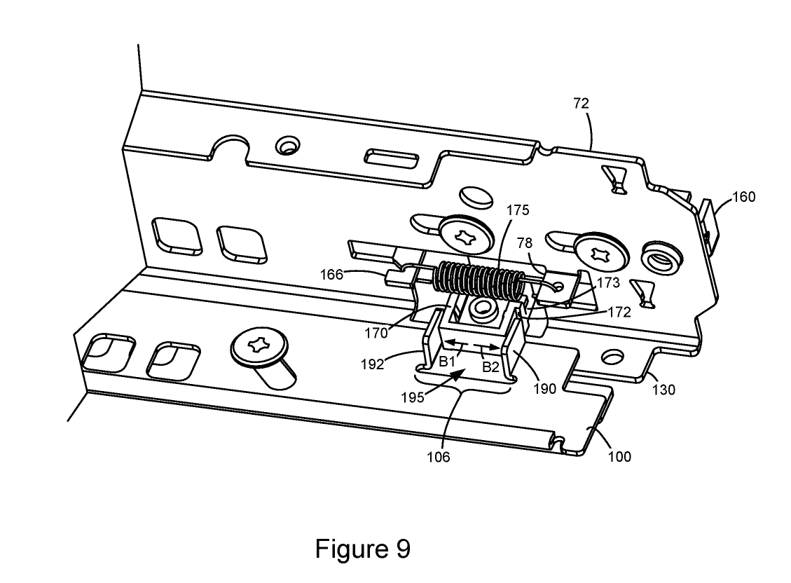

In a further embodiment, a locking mechanism for shutter 100 is provided to prevent a user from manually opening shutter 100 from its blocking position. This ensures that the purpose of shutter 100, which is to block off user access to interior components of fuser 40, is not defeated by a user attempting to otherwise manually or forcefully raise shutter 100 while fuser 40 is in its operational position within imaging device 10. With reference to FIG. 9, retainer 106 includes a pair of spaced apart first and second restraints 190, 192 forming a slot 195 therebetween with slot 195 having a width that is sized to receive insert 170 of slider 160. In this example, the width of slot 195 is greater than a width of insert 170. The size difference between insert 170 and slot 195 allows for insert 170 to move laterally, as indicated by arrows B1, B2, within slot 195 of retainer 106. A stop feature 172 is provided on a side 173 of insert 170 facing first restraint 190 and is arranged to obstruct upward movement of shutter 100 relative to upper frame 72 while slider 160 is in its unpushed position.

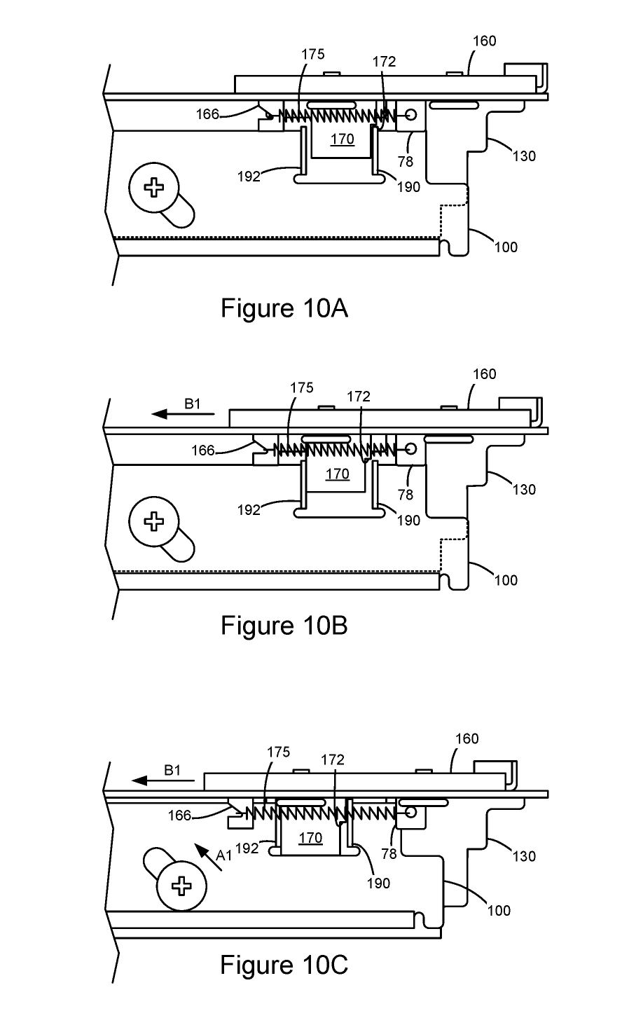

The operation of the locking mechanism for shutter 100 will be described with reference to FIGS. 10A-10B. In FIG. 10A, slider 160 is in the unpushed position and shutter 100 is in the blocking position. The biasing force of tension spring 175 moves insert 170 to contact against first restraint 190 while stop feature 172 vertically aligns above first restraint 190. In this arrangement, any attempt to raise shutter 100 relative to upper frame 72 is prevented due to stop feature 172 obstructing upward movement of first restraint 190 such that shutter 100 is restricted from being manually opened and remains in the blocking position while slider 160 is in the unpushed position. In FIG. 10B, slider 160 is initially moved in direction B1 to an extent that insert 170 makes initial contact against second restraint 192 while shutter 100 remains in the blocking position. In this arrangement, stop feature 172 is vertically misaligned relative to first restraint 190. The misalignment between stop feature 172 and first restraint 190 and the engagement between insert 170 and second restraint 192 allows slider 160 to pull shutter 100 diagonally upward in direction A1 towards the unblocking position as slider 160 moves in direction B1 towards its fully-pushed position as shown in FIG. 10C. Insert 170 and/or second restraint 192 may be made from materials having relatively small coefficient of friction to reduce frictional resistance when insert 170 slides against second restraint 192 as slider moves laterally in direction B1 and pulls shutter 100 with it to move shutter in direction A2.

The above sequence is reversed when the actuation force moving slider 160 in direction B1 is removed. The biasing force of tension spring 175 moves slider 160 back to the unpushed position (FIG. 10A) causing insert 170 to contact against first restraint 190 and pull shutter 100 towards the blocking position until first restraint 172 is positioned vertically below stop feature 172.

Referring back to FIG. 4, additional safety features of fuser 40 include media path ribs located at the exit 50 of fuser 40 that block off possible user contact with interior components of fuser 40 when exit 50 is exposed to access by a user, such as when a rear access door to the imaging device is opened and fuser exit 50 is unobstructed. Upper guide member 146 includes a plurality of parallel ribs 147 that are used to support media passing through exit 50. Ribs 147 cooperate with corresponding ribs 145 of lower guide member 144 to reduce surface contact between media being fed and inner surfaces of upper and lower guide members 144, 146 during feeding of media sheets through fuser 40 in order to reduce drag and possible media skewing. In the example shown, ribs 147 on upper guide member 146 are spaced across the width of exit 50 such that the gap between adjacent ribs is between about 5 mm and 10 mm to prevent a user's finger from entering fuser 40 through exit 50 and contacting interior components of fuser 40. The arrangement of ribs 147 may reduce risks of shock, burn, and/or other possible physical injuries that may result from insertion of a user's finger into fuser 40 via exit 50.

The above example embodiments teach the use of a safety shutter at the entrance of an HTC belt fuser. It is understood, however, that the concept of providing a safety shutter at the entrance of a fuser assembly may be implemented in other fuser assemblies having a different fuser belt architecture or even a different architecture from a fuser belt based architecture. For example, safety shutters may be implemented in a hot roll fuser including a heated roll and a backup roll engaged therewith to form a fuser nip through which media sheets traverse. In addition, although the above example implementation shows shutter 100 moving in a diagonal direction, other implementations may include movement of shutter 100 in other directions, such as vertical, rotational, or a combination thereof to uncover and cover the entrance of the fuser. Further, other actuation mechanisms for moving the shutter between the blocking and unblocking positions relative to the fuser entrance in response to an access door opening and closing, respectively, may be implemented.

The foregoing illustrates various aspects of the invention. It is not intended to be exhaustive. Rather, it is chosen to provide the best mode of the principles of operation and practical application known to the inventors so one skilled in the art can practice it without undue experimentation. All modifications and variations are contemplated within the scope of the invention as determined by the appended claims. Relatively apparent modifications include combining one or more features of one embodiment with those of another embodiment.

1. A fuser assembly for an imaging device, comprising:
a housing having a front and a rear, the front having a first opening through which a media sheet with a toner image enters the fuser assembly to fuse the toner image onto the media sheet and the rear having a second opening through which the media sheet with fused toner image exits the fuser assembly;
a shutter mounted on the front of the housing and movable between an unblocking position and a blocking position relative to the first opening, in the unblocking position the shutter uncovers the first opening and in the blocking position the shutter covers at least a portion of the first opening; and
an engagement member movably mounted and exposed on a side of the housing for receiving an actuation force, the engagement member operatively connected to the shutter such that the engagement member moves the shutter from the blocking position to the unblocking position upon receiving the actuation force.

2. The fuser assembly of claim 1, wherein when the fuser assembly is installed in the imaging device, the engagement member receives the actuation force in response to an access door of the imaging device being closed.

3. The fuser assembly of claim 1, wherein the engagement member moves toward a central portion of the housing upon receiving the actuation force which moves the shutter towards the unblocking position.

4. The fuser assembly of claim 1, wherein movement of the engagement member towards the side of the housing moves the shutter towards the blocking position.

5. The fuser assembly of claim 1, wherein the engagement member is spring-biased towards the side of the housing to urge the shutter towards the blocking position.

6. The fuser assembly of claim 1, wherein the engagement member includes an insert and the shutter includes a retainer receiving the insert such that the engagement member and the shutter are operatively connected to each other.

7. The fuser assembly of claim 6, wherein the insert includes a stop feature positioned to block the shutter from moving towards the unblocking position while no actuation force is imparted to the engagement member.

8. The fuser assembly of claim 1, wherein the housing includes a plurality of cutout geometries and the shutter includes a plurality of perforations that align with corresponding cutout geometries of the housing when the shutter is in the unblocking position.

9. The fuser assembly of claim 1, wherein the shutter is made of sheet metal.

10. A fuser assembly for an imaging device, comprising:
a housing having a front and a rear, the front having a first opening through which a media sheet with a toner image enters the fuser assembly to fuse the toner image onto the media sheet and the rear having a second opening through which the media sheet with fused toner image exits the fuser assembly; and
a shutter mounted on the front of the housing and movable between an unblocking position and a blocking position relative to the first opening, in the unblocking position the shutter uncovers the first opening and in the blocking position the shutter covers at least a portion of the first opening;
wherein when the fuser assembly is installed in the imaging device, the shutter is operative to move from the blocking position to the unblocking position upon the fuser assembly receiving an actuation force from the imaging device in response to an access door of the imaging device being closed.

11. The fuser assembly of claim 10, wherein the shutter is operative to move from the unblocking position to the blocking position upon removal of the actuation force in response to the access door being opened.

12. The fuser assembly of claim 10, wherein the shutter is spring-biased towards the blocking position.

13. The fuser assembly of claim 10, further comprising an engagement member positioned on a side of the housing to receive the actuation force from the imaging device, the engagement member operatively connected to the shutter such that the engagement member moves the shutter towards the unblocking position upon receiving the actuation force.

14. The fuser assembly of claim 13, further comprising a bias member coupled between the housing and the engagement member, the bias member urging the engagement member towards the side of the housing to urge the shutter towards the blocking position.

15. The fuser assembly of claim 13, wherein the engagement member includes a stop feature positioned to block the shutter from moving towards the unblocking position in the absence of the actuation force.

16. An imaging device, comprising:
a housing having an opening to receive one or more customer replaceable units;
an access door mounted on the housing and movable between an open position and a closed position relative to the opening;
a fuser assembly having a front facing the access door and defining an entrance opening through which a media sheet with a toner image enters the fuser assembly to fuse the toner image onto the media sheet, and a shutter mounted on the front and movable between an unblocking position and a blocking position relative to the entrance opening, in the unblocking position the shutter uncovers the entrance opening and in the blocking position the shutter covers at least a portion of the entrance opening; and
a linkage on a side of the housing extending between the fuser assembly and the access door, the linkage operatively connected to the shutter such that the shutter moves from the blocking position to the unblocking position when the linkage receives a forward force from the access door that is toward the front of the fuser assembly as the access door is moved from the open position to the closed position.

17. The imaging device of claim 16, wherein the shutter moves from the unblocking position to the blocking position upon removal of the forward force on the linkage as the access door is moved from the closed position to the open position.

18. The imaging device of claim 16, further comprising an actuator mounted on the side of the housing between the linkage and the fuser assembly, wherein the linkage engages the actuator upon receiving the forward force and the actuator is operative to convert the forward force to an actuation force on the fuser assembly to move the shutter from the blocking position to the unblocking position.

19. The imaging device of claim 18, wherein the fuser assembly includes an engagement member positioned on a side of the fuser assembly to receive the actuation force from the actuator, the engagement member operatively connected to the shutter such that the engagement member moves the shutter towards the unblocking position upon receiving the actuation force from the actuator.

20. The imaging device of claim 16, wherein the shutter is spring-biased towards the blocking position.
